(19) United States
(12) Patent Application Publication
(10) Pub. No.: US 2001/0034761 A1
(43) Pub. Date: Oct. 25, 2001

(54) Internet connection service system

(75) Inventor: Hitoshi Matsui, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/840,031

(22) Filed: Apr. 24, 2001

(30) Foreign Application Priority Data
Apr. 25, 2000 (JP) 2000-124027

(51) Int. Cl. G06F 15/16

(52) U.S. Cl. 709/203

(57) ABSTRACT

An Internet connection service system allowing users to easily access the Internet at a low cost is disclosed. A parking lot has a plurality of parking spaces arranged therein. Plural communication devices are installed in respective ones of the plurality of parking spaces. Each of the communication devices is allowed to communicate with a user terminal provided in a car parked in a corresponding parking space. A switching device is connected to the communication devices and allows the user terminal to be connected to the Internet in response to an Internet connection request received from the user terminal.

### BACKGROUND OF THE INVENTION

1. Field of the Invention

The present invention relates to a high-speed Internet connection service system, which can provide a high-speed Internet access service to a plurality of users.

2. Description of the Related Art

In recent years, an increasing number of users access the Internet to obtain various services and exchange electronic mails. Since, at each home of personal users, a telephone subscriber line is used to make a dial-up IP (Internet Protocol) connection, a transmission speed of Internet connection is generally 100 kbps or less. Therefore, in the case of transmission of a large amount of data such as music data, it takes much time to transfer, so that a user cannot obtain a satisfactory service.

For example, several tens megabytes of data are needed for ten tracks compressed by MP3 (MFEG layer 3) that is an audio data compression system of MPEG (Moving Picture Experts Group)-1. When such a large amount of data is transferred at 100 kbps, it takes about one hour. If a 10-Mbps line is provided, the transfer time is shortened to about 30 seconds, resulting in substantially reduced burden on the user.

To increase a transmission speed, an ADSL (asymmetric digital subscriber line), an optical fiber, or a wireless channel can be additionally used to provide services. However, such high-speed lines are locally restricted for the present and therefore the high-speed services cannot be obtained by all Internet users.

### SUMMARY OF THE INVENTION

An object of the present invention is to provide an Internet connection service system allowing users to easily access the Internet at a low cost with reducing the inconvenience of users going to a high-speed access point such as a so-called Internet café.

According to the present invention, a system includes: a parking lot having a plurality of parking spaces arranged therein; a plurality of communication devices installed in respective ones of the plurality of parking spaces, wherein each of the communication devices Is allowed to communicate with a user terminal provided in a car parked in a corresponding parking space; and a switching device connected to the communication devices, wherein the switching device allows the user terminal to be connected to the Internet in response to an Internet connection request received from the user terminal.

The switching device may be connected to the Internet through a high-speed data communication line. The switching device may be connected to a network system provided In a store, wherein the network system is connected to the Internet through a high-speed data communication line.

Each of the plurality of communication devices may be provided with a directional antenna directed to the car to allow wireless communication using a small-power or weak radio wave.

The parking lot may be an open-air parking lot, wherein each of the plurality of communication devices is provided at a tip of a pole having a predetermined height. The parking lot may be an indoor parking lot, wherein each of the plurality of communication devices is provided on a ceiling of the indoor parking lot.

According to another aspect of the present invention, a method for connecting a user terminal to the Internet, includes the steps of: a) preparing a parking lot having a plurality of parking spaces arranged therein; b) preparing a plurality of communication devices installed in respective ones of the plurality of parking spaces, wherein each of the communication devices is allowed to communicate with a user terminal provided in a car parked in a corresponding parking space; a) receiving an Internet connection request from the user terminal provided in the car parked in the corresponding parking space; and d) connecting the user terminal to the Internet depending on the Internet connection request.

The Internet connection request may include an identification number that has been uniquely assigned to a user of the user terminal, wherein the step d) includes the steps of: determining whether the identification number is authenticated; when the identification number is authenticated, connecting the user terminal to the Internet.

### BRIEF DESCRIPTION OF THE DRAWINGS

FIG. 1 is a schematic diagram showing an example of Internet connection system according to an embodiment of the present invention;

FIG. 2 Is a block diagram showing the system configuration of the embodiment;

FIG. 3 is a flow chart showing a schematic operation of the embodiment; and

FIG. 4 is a sequence diagram showing the operation of the embodiment.

### DESCRIPTION OF THE PREFERRED EMBODIMENT

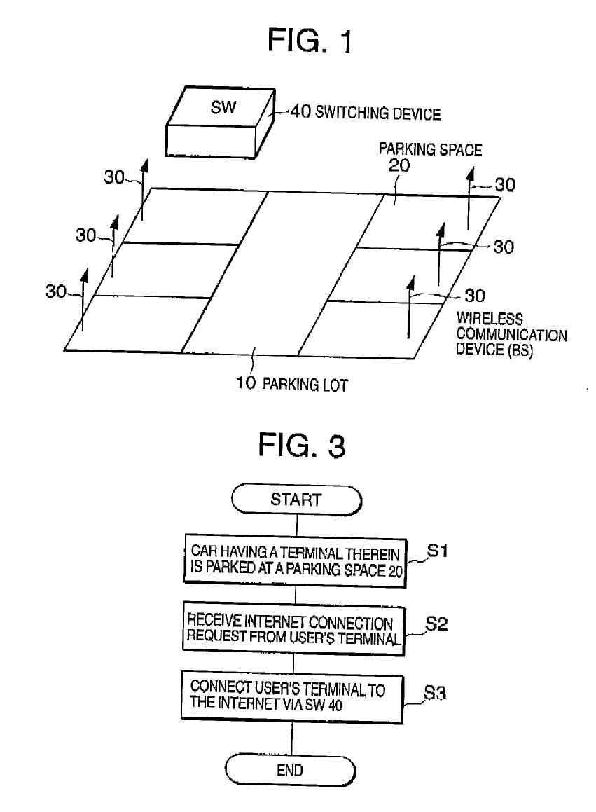

Referring to FIG. 1, an Internet connection service system according to an embodiment of the present invention is composed of a parking lot 10 having a plurality of parking spaces 20, a wireless communication device (BS) 30 arranged for each parking space 20, and a switching device 40, The switching device 40 performs centralized control of the wireless communication devices 30, allowing a plurality of users to access the Internet.

The parking lot 10 is an ordinary parking lot in which the parking spaces 20 are regularly arranged in one plane. Each of the parking spaces 20 has a wireless communication device 30 installed on one side thereof. When receiving information from a user terminal with a small-power or weak radio wave, a corresponding wireless communication device 30 transfers it to the switching device 40. On the other hand, when the wireless communication device 30 receives information addressed to the user terminal from the switching device 40, the wireless communication device 30 transmits it to the user terminal with a small-power or weak radio wave. The switching device 40 controls information transmission between each of the wireless communication devices 30 and the high-speed transmission line connected to the Internet.

A terminal owned by a user (user terminal) is a portable terminal having a wireless communication function added to an information processing device such as a personal computer. The user terminal has a function of accessing the Internet via the wireless communication device 30 and the switching device 40. In the case of a large-sized store or hypermarket having a sufficient number of parking spaces 20 and a high-speed data line, the wireless communication devices 30 and the switching device 40 can be installed at a relatively low cost, and various net services in the store are also available to users.

### System Configuration

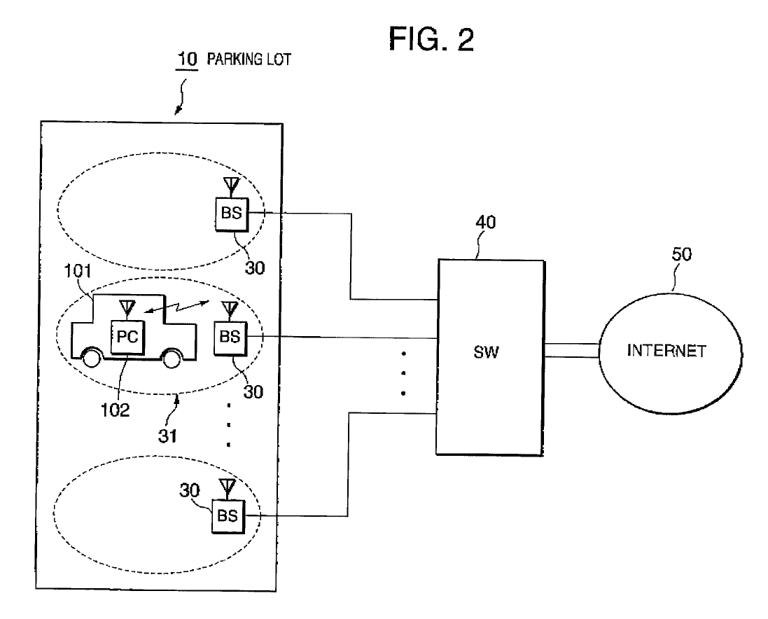

Referring to FIG. 2, the wireless communication devices (BS) 30 are arranged on the parking lot 10 and are connected to the switching device 40. The switching device 40 is installed within the store and is connected to the Internet via a high-speed data line. The switching device 40 may be connected to a network system connected to the Internet within the store.

Each of the wireless communication devices (BS) 30 forms a radio area 31 in a corresponding parking space 20. When a user parks a car 101 having a user terminal (PC) 102 therein at an available parking space 20, the user terminal 102 communicates with the wireless communication device (BS) 30 of the parking space 20 to obtain various services including the Internet connection.

Also, an Internet connection charge may be paid by the amount of connect time when the line is disconnected. For example, the charge is automatically paid from the user's bank account. Alternatively, a fixed charge may be paid at the time of access to the Internet. Further, when music data and video data are transferred to a user terminal, the royalties thereof are included in the charge.

Here, the wireless communication between the wireless communication device 30 and the switching device 40 is performed on, for example, the ISM band (Industrial, Scientific, and Medical band) of 2.4 GHz that can be used by anybody without a license. Further, in the case of the wireless communication device 30 having a directional antenna installed thereto, interference of radio waves from other wireless communication devices can be effectively prevented. Since a single user terminal can use exclusively one frequency of the service area, a broader band of frequencies required for high-speed communication can be allocated to the user terminal 102, compared with the case where a plurality of user terminals use simultaneously the one frequency of the service area. Therefore, each user can communicate at the speed of 10 Mbps or faster on the ISM band of 2.4 GHz.

Since the directional antenna provided to the wireless communication device 30 increases the antenna gain, the communication between the wireless communication device 30 and the user terminal 102 can be performed with a relatively small transmission power. Therefore, both the user terminal 102 and the wireless communication device 30 are allowed to reduce in size, price and power consumption.

In an open-air parking lot 10, the wireless communication device 30 may be installed at the tip of a steel pole 2-3 meters in height to reduce in construction cost and maintenance cost. In an indoor parking lot 10, the wireless communication device 30 may be installed on the ceiling to reduce in construction cost and maintenance cost.

In a large-size store having a huge parking lot and a high-speed data communication line already installed, the switching device 40 is connected to each of the wireless communication devices 30 via its high-speed data communication line and is further connected to the Internet line allowing TP connection via a dedicated line, resulting in smooth and effective communication between each wireless communication device 30 and the Internet. This allows the store to provide various network services thereof to the user terminals 102 of cars 101 parked in the parking lot 10. For example, a large amount of data such as music data or video data can be efficiently provided to each user. Such a large amount of data cannot be provided to an ordinary home through the Internet at sufficiently high speeds.

### Operation

Referring to FIG. 3, when a user wants to access the Internet while driving a car 101 having a user terminal (PC) 102 therein, the user parks the car 101 at an empty parking space 20 (step S1). After having parked the car 101, the user operates the user terminal 102 to transmit an Internet connection request to the wireless communication device 30 of the parking space 20 and thereby the wireless communication device 30 receives the connection request (step S2). When receiving the connection request from the user terminal 102, the wireless communication device 30 transfers it to the switching device 40. The switching device 40 connects the user terminal 102 to an access point or a desired site on the Internet in response to the received connection request (step S3). In this manner, the user terminal 102 can communicate with the desired site on the Internet at sufficiently high speeds through the wireless communication device 30 and the switching device 40.

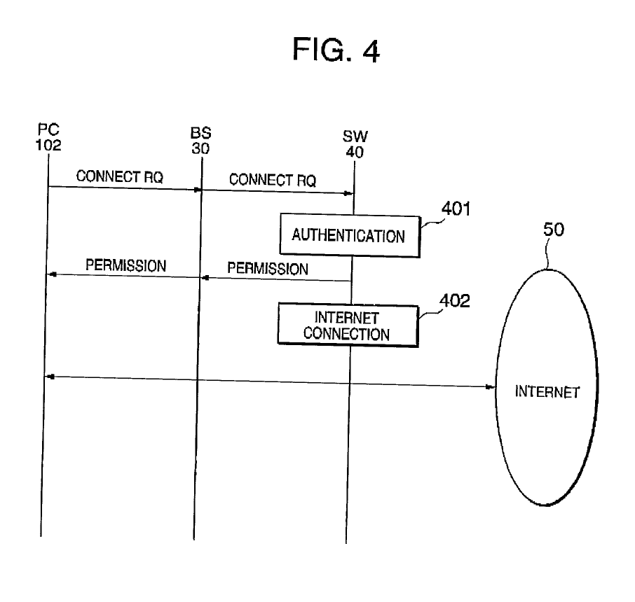

Referring to FIG. 4, an example will be described. When having parked the car 101, the user operates the user terminal 102 to transmit an Internet connection request to the nearest wireless communication device 30. The Internet connection request includes the identification number (ID) that has been uniquely assigned to the user. When receiving the Internet connection request, the wireless communication device 30 transfers it to the switching device 40.

Upon receipt of the Internet connection request from the wireless communication device 30, the switching device 40 determines whether the ID number included in the Internet connection request should be permitted (step 401). When the ID number has been authenticated, the switching device 40 transmits a login permission signal to the user terminal 102 through the wireless communication device 30. Thereafter, the switching device 40 performs necessary operations to connect the user terminal 102 to the Internet 50 (step 402) and then the user terminal 102 can communicate with the desired site on the Internet 50.

As described above, a high-speed data communication service can be realized in a large-size store with a small capital investment, so that a user can obtain the high-speed Internet access service at a lower cost.

Further, since a single user terminal can use exclusively one frequency, the high-speed data communication can be achieved at a reasonable cost. Then, in the present embodiment, since a user terminal is used in a car, the data communication can be performed ensuring almost the same condition as that of indoors.

The present invention is not restricted to the above-described embodiment. For example, the parking lot 10 may be owned by a different company. Instead of the wireless communication device 30, an optical communication device or a wired communication device may be also used.

According to the present invention, a communication device capable of Internet connection is prepared for each parking space in a parking lot to allow user terminals in the cars to obtain various network services. Therefore, the present invention has various advantages as follows.

1) Personal users can easily access the Internet at a higher speed than at home. If such a high-speed data communication is realized at home, the personal user needs a significant investment. Therefore, as a matter of cost, a user at home has not obtained data communication beyond using the Internet line. Since the parking lot of d large-size store is used as the space at which services are obtained, the matter of cost can be settled and the user terminals in the cars parking at the parking lot can use an existing high-speed data communication facility installed to the store. Also, since the users have to just go to a parking lot by cars instead of visiting an Internet café, they can reduce the inconvenience of moving access positions without being afraid of weather. In addition, since the service spot is a parking lot, large differences between various regions involved in, for example, a cable television service, can be reduced, because all of people having cars around the area can obtain the same service.

2) A high-speed communication service can be realized at a reasonable cost. In a mobile communication system, a transmission speed allocated to one user is restricted, because a plurality of users simultaneously use in a single service area. According to the present invention, however, a directional antenna of each wireless communication device allows a single user terminal to use exclusively one frequency in the service area. Therefore, even the data communication at speeds of 100 Mbps or faster can be realized at a relatively low cost.

3) The data communication can be performed mostly in the same condition as that of indoors, because a user can operate the user terminal in the car. Since a room in the car is similar to a private room and is less sensitive to weather, the data communication can be performed In the mostly same condition as that of indoors. The service provider can provide the outdoor service to users at a lower cost, because they have no need of preparing for indoor spaces for them,

4) A data communication service can be provided at a small capital investment. A large-size store having a large parking `lot and a high-speed data line provides the data communication service. In many large-size stores, a fully-equipped parking lot and a high-speed data line for business use are provided and these facilities can be used to provide the services In the present invention. Also, although the parking lot and the data line are ineffectively used at a night hour or a holiday, the present invention allows more effective use of these facilities

5) Users can obtain net services of a store early. Since users in parking lots can obtain the net information of the store without accessing the Internet, high-speed and early data transfer to users can be achieved. Therefore, a large amount of data such as music data can be transmitted in a relatively short time. This may develop a new business to provide information.

1. A system comprising:
a parking lot having a plurality of parking spaces arranged therein:
a plurality of communication devices Installed in respective ones of the plurality of parking spaces, wherein each of the communication devices is allowed to communicate with a user terminal provided in a car parked in a corresponding parking space; and
a switching device connected to the communication devices, wherein the switching device allows the user terminal to be connected to the Internet in response to an Internet connection request received from the user terminal.

2. The system according to claim 1, wherein the switching device is connected to the Internet through a high-speed data communication line.

3. The system according to claim 1, wherein the switching device is connected to a network system provided in a store, wherein the network system is connected to the Internet through a high-speed data communication line.

4. The system according to claim 1, wherein each of the plurality of communication devices is provided with a directional antenna directed to the car to allow wireless communication using a small-power or weak radio wave,

5. The system according to claim 1, wherein the parking lot is an open-air parking lot, wherein each of the plurality of communication devices is provided at a tip of a pole having a predetermined height.

6. The system according to claim 1, wherein the parking lot is an indoor parking lot, wherein each of the plurality of communication devices is provided on a ceiling of the indoor parking lot.

7. A method for connecting a user terminal to the Internet, comprising the steps of:
a) preparing a parking lot having a plurality of parking spaces arranged therein;
b) preparing a plurality of communication devices installed in respective ones of the plurality of parking spaces, wherein each of the communication devices is allowed to communicate with a user terminal provided in a car parked in a corresponding parking space:
c) receiving an Internet connection request from the user terminal provided in the car parked in the corresponding parking space; and
d) connecting the user terminal to the Internet depending on the Internet connection request.

8. The method according to claim 7, wherein the Internet connection request includes an identification number that has been uniquely assigned to a user of the user terminal,
wherein the step d) comprises the steps of:
determining whether the identification number is authenticated;
when the identification number is authenticated, connecting the user terminal to the Internet.

9. The method according to claim 7, wherein the plurality of communication devices are connected to the Internet through a high-speed data communication line.

10. The method according to claim 7, wherein the plurality of communication devices are connected to a network system provided in a store, wherein the network system is connected to the Internet through a high-speed data communication line.

11. An Internet connection service device comprising:
a plurality of wireless communication devices, each of which communicates with a user terminal provided in a car parked within an area at a predetermined distance from the wireless communication device: and
a switching device connected to the communication devices, wherein the switching device allows the user terminal to communicate with a desired site on the Internet in response to an Internet connection request received from the user terminal.
